(19) United States
(12) Patent Application Publication
(10) Pub. No.: US 2014/0171196 A1
(43) Pub. Date: Jun. 19, 2014

(54) Control Panel

(71) Applicant: Damien Coyle, Co. Donegal (IE)

(72) Inventor: Damien Coyle, Co. Donegal (IE)

(73) Assignee: UNIVERSITY OF ULSTER, County Londonderry (UK)

(21) Appl. No.: 14/124,740

(22) PCT Filed: Jun. 11, 2012
(86) PCT No.: PCT/GB2012/051312

§ 371 Date: Mar. 3, 2014

(30) Foreign Application Priority Data
Jun. 9, 2011 (GB) 1109638.5

(51) Int. Cl. A63F 13/20

(52) U.S. Cl. CPC A63F 13/06
USPC 463/31

(57) ABSTRACT

A control panel for controlling the actions of an object using Brain Computer Interface technology. The panel includes a plurality of controls (1) adapted to select a plurality of actions. The control comprises a visible marker (7, 8, 9), and means for effecting continuous relative rotation of the marker with respect to a background (6). The background includes at least one visible target sector (5). The control further comprises a visible indicator (12) whose extent can be varied by a user whilst there is relative rotation between the marker and the background. For an action to be selected, alignment of the marker and the target sector must coincide with the indicator (12) having reached a predetermined extent (11). The control may be adaptive to display differing numbers of markers and different target sectors, depending on the actions permissible at any given time.

This invention relates to a control panel, for example for use in controlling the movements of a robot, a vehicle or characters or objects in a video game. More particularly, but not exclusively, the invention is concerned with such a control panel that is adapted for use in conjunction with Brain Computer Interface (BCI) technology.

BCI technology enables communication which does not rely on neuromuscular control, thereby offering alternative communicatory and control mechanisms to those who have limited movement capacity due to disease, or spinal/brain damage. BCI is also used in rehabilitation and by able-bodied individuals in gaming and entertainment. BCIs are often controlled using motor imagery (movement imagination). Normally in motor imagery BCIs two movement imaginations (such as left/right hand movement imagination) are used to provide discrete binary communication for 0/1 or yes/no or for continuous control were the control signal fluctuates in time and magnitude (greater than 0 or less than 0). This can be used to interact with virtual spellers, wheelchairs and games.

BCI accuracy limits communication bandwidth provided by BCI. There is a low information transfer rate between the user and the computer compared to other interface devices such as keyboard and games controllers. If there are only two classes (i.e. two motor imageries) the maximum information transfer rate per communication is 1 bit (assuming 100% accuracy). If the number of classes is increased (for example to include foot and tongue motor imagery) the maximum information transfer rate is 2 bits per communication assuming 100% accuracy. Rarely is 100% accuracy achievable in brainwave based communication using two classes and, as the number of classes increase, accuracy tends to decrease. There is a limit to the number of imagery classes feasible using non-invasive EEG-based BCI.

There has been proposed a BCI controller which comprises a visible marker, and a system for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent.

In one such arrangement there is a plurality of circumferentially spaced markers corresponding to a plurality of actions for the control, and to select a particular action corresponding to a particular marker, that marker must be aligned with the target sector. There are three possible actions and thus three equally spaced circumferentially arranged markers. The background is a circle around which the markers rotate continuously. A minor segment of the circle is marked to identify it as the target sector.

In another known arrangement, there is single marker and there is a plurality of visible sectors of the background which are allocated to respective ones of the plurality of actions for the control, and to select a particular action corresponding to a particular sector, the marker must be aligned with that particular sector. The marker further serves as the visible indicator whose extent can be varied by a user, and is in the form of a bar of variable extent which sweeps around the background. The background is in the form of a circles which is divided into segments.

A first aspect of this invention provides a more versatile arrangement than these proposals.

According to a this aspect of the present invention, there is provided a control panel comprising a plurality of individual controls, each of which is adapted to select a plurality of actions, wherein each control comprises a visible marker, and a system for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent.

In one preferred embodiment for each individual control there is a plurality of circumferentially spaced markers corresponding to the plurality of actions for the control, and to select a particular action corresponding to a particular marker, that marker must be aligned with the target sector. In a preferred embodiment, there are four controls, each with three or more possible actions, i.e. with three or more equally spaced circumferentially arranged markers. Preferably in each control, the background is a circle around which the markers rotate continuously. A minor segment of the circle, such as a third, is marked to identify it as the target sector.

In such an arrangement, the visible indicator may be a bar whose extent varies, with a line or the like showing the extent that the bar must reach for an action to be selected.

The individual controls could be mechanically or electrically implemented by means of moving objects or lights that are illuminated in sequence. In a preferred embodiment, they are virtual items displayed on a screen such as the screen of a computer.

In an alternative arrangement, for each individual control there is single marker, and there is a plurality of visible sectors of the background which are allocated to respective ones of the plurality of actions for the control, and to select a particular action corresponding to a particular sector, the marker must be aligned with that particular sector. Preferably, the marker further serves as the visible indicator whose extent can be varied by a user. Preferably, the marker is in the form of a bar of variable extent which sweeps around the background. The background is preferably in the form of a circles, which may be divided into segments, such as three or more equally sized segments. Preferably there are four of these individual controls. Again, this arrangement may be implemented mechanically or electrically, but preferably is in the form of virtual items displayed on a screen such as the screen of a computer.

In some embodiments of the invention, the visible indicator whose extent can be varied by a user is separate from the or each visible marker. Preferably the indicator is linear although a curved arrangement would be possible. The indicator could be continuous or consist of separate sections.

Preferably, the control panel is connected to a brain-computer interface for a user to select actions without physical manipulation by altering the extent of the indicator. Preferably, the brain-computer interface permits a user to select actions by movement imagination. Preferably, the panel is further connected to a system for controlling actions of one or more objects in accordance with the selected actions.

In the preferred embodiments, each individual control is adapted to select from a choice of no more than three actions. In the preferred embodiments, there are two, three or four individual controls in the control panel.

In some embodiments of this aspect of the invention, each individual control has an adaptive appearance which changes in accordance with the number of options that the control is permitted to select, so that the number of target sectors and/or the number of markers is varied. For example, in some cases there may be instances in which no options are available and the control will be blank; instances in which there is only one option and there is one marker and an entire circle is the target sector; instances with two options so that the target sector is a semicircle; instances with three options or instances with four options. The nature of the options may also alter, and there may be variable text legends indicating which marker corresponds to which action in any particular configuration.

For example, if using the control panel to control the movements of a robot there may be, for example, a maximum of six possible commands which could be nominally assigned to two controls with three possible actions. At any particular point in time whilst controlling the robot, there may be fewer than the maximum actions possible; for example if the robot is up against an obstacle, moving forwards is not an option, and this could be removed from the available actions. If the control panel is used to operate a video game, again the appearances of the controls could adapt to the options available at any given time. For example, in a video game using a number weapons to launch at a moving target, some could be assigned to one control and some to another initially. If the game is such that once a weapon is launched then that weapon is no longer available, the launch of a weapon could result in adaptation of its control, so as to remove that as an option.

An adaptive control of this type is inventive in its own right and thus viewed from a second aspect the invention provides a control for selecting one of a plurality of actions, wherein the control comprises a visible marker, and a system for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent; and wherein the control is adaptive so that the number of possible actions is varied and the marker and/or background is varied accordingly.

In an arrangement in which the control has a plurality of circumferentially spaced markers corresponding to the plurality of actions for the control, and to select a particular action corresponding to a particular marker, that marker must be aligned with the target sector, the control may be adaptive to display differing numbers of markers. If the number of markers is reduced, in some embodiments the size of the target sector is increased at the same time. In an alternative arrangement the control has a single marker, and there is a plurality of visible sectors of the background which are allocated to respective ones of the plurality of actions for the control, and to select a particular action corresponding to a particular sector, the marker must be aligned with that particular sector. In such an arrangement the control may be adaptive to display differing numbers of sectors of the background, in accordance with the number of options available.

The adaptive control may be adaptive in the sense of being capable of configuration prior to use for a particular purpose, and/or may be adaptive in the sense of adapting during use to differing numbers of options becoming available.

Other features of the individual controls discussed above in relation to the control panel with multiple controls, are also applicable to the control of this second aspect of the invention Likewise, features of this second aspect of the invention are applicable to the individual controls of the control panel of the first aspect of the invention.

Preferred embodiments of the invention increase the IT (Information Transfer) rate using four classes—i.e. four individual controls—and providing the user with the three options for every class, with each option being selectable approximately every 2 seconds. This is achieved in preferred embodiments through four rotating circles or annular portions. Each circle or annular portion has three markers in the form of cursors (such as small coloured circles) located equidistant from each other and each circle is manipulated by one of the four motor imageries. The circle or annular portion performs a full rotation every 2 to 3 seconds.

If using one motor imagery the accuracy is not reduced (one motor imagery) although an information transfer rate of potentially 1.5 bits per communication can be achieved. Extending this to 4 circles, with each circle being linked to a particular motor imagery enables a total of 12 options to be selected with just 4 motor imagery classes, increasing the potential information transfer rates to 3 and 4 bits per communication, for example approximately 3.6 bits.

The first aspect of the invention thus provides a control panel which allows 12 classes to be selected using one motor imagery approximately every 2 to 3 seconds, for example approximately 2.4 seconds, thus increasing the maximum information rate from 2 bits per trial to a maximum of ˜3.6 bit per trial given 4 class BCI accuracy.

Brain controlled video games can be used in training users to intentionally modulate their brainwaves for communication (for those with severe movement issues), in rehabilitation (post stroke rehab to encourage brain repair) and, of course, for gamers, to augment and improve the game playing experience. BCI-games controllers are adding to the continual demand for new ways to interact with games following trends such as the Wii™ and Kinect™. Current BCIs offer limited game play control and there is a necessity to offer the user more options. This can be done using visual evoked potentials (VEP) which are different to motor imagery however VEP based designs have different consideration, limitations and shortcomings. In preferred embodiments of the invention, the control panel can be used to control functions of a game. Thus, in preferred embodiments the control panel described above is adapted to control actions in a game presented on a screen. Preferably, the individual controls are presented on the screen on which the game is presented. Preferably, four individual controls are provided, one adjacent each corner of the screen.

Indeed, using just one of the individual controls can provide sufficient control features of a game, particularly if there are four actions rather than three—i.e. four markers in one type of design or four sectors in the other type of design. Using such a control as a games controller provides up to four commands in an effective manner with one motor imagery. This provides the same number of options as many standard games controllers. However it must be noted that it is still a much slower and inaccurate interface than a standard games controller. Nevertheless, this offers many options for new brainwaves controlled computer games. Few if any brainwave controlled “Fighter” games (Fighter is a type of game genre) have yet been developed.

Thus viewed from another aspect of the invention, there is provided video game apparatus including a controller adapted to select a plurality of actions, wherein the controller comprises a visible marker, and means for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent.

In one preferred embodiment for the controller there is a plurality of circumferentially spaced markers corresponding to the plurality of actions for the control, and to select a particular action corresponding to a particular marker, that marker must be aligned with the target sector. In a preferred embodiment, there are three or four or more possible actions, i.e. with three or four or more equally spaced circumferentially arranged markers. Preferably the background is a circle around which the markers rotate continuously. A minor segment of the circle, such as a third or a quarter, is marked to identify it as the target sector.

In an alternative embodiment, the controller has a single marker, and there is a plurality of visible sectors of the background which are allocated to respective ones of the plurality of actions for the control, and to select a particular action corresponding to a particular sector, the marker must be aligned with that particular sector. Preferably, the marker further serves as the visible indicator whose extent can be varied by a user. Preferably, the marker is in the form of a bar of variable extent which sweeps around the background. The background is preferably in the form of a circle, which may be divided into segments, such as three or four or more equally sized segments.

Other features of the controls referred to in relation to the first and second aspects of the invention are also applicable to this aspect of the invention.

Video games adapted for use with a control panel in accordance with the invention can be controlled using for example keystrokes such as the four arrow keys on a keyboard or four buttons on a smart phone keypad or display screen. There will be a one or more individual controls with a number of actions, and a key to activate the indicator or “feedback bar”. Users must time the key press to perform the correct action with the control concerned. This offers a challenge to able-bodied games players. Key press reaction time sensitivity can be altered along with circle rotation speed to increase the challenge. More circles and rotation can be incorporated to create a gaming interface which is increasingly complex for able bodied users but increasingly challenging and exciting to play. Such an interface involving timing and rhythmic control of feedback bars and rotating circles is not yet available.

Timing and rhythm form key elements of many games. Rhythm challenges, tests of the player's ability to press the right button at the right time, feature in dance games and many others. The popularity of rhythm-based games has resulted in a significant aftermarket in speciality input devices including dance mats, electronic drums and guitars.

In addition, many fighting games require complex sequences of joystick moves and controller button presses that, once mastered, allow the players “avatar” to perform powerful features. Executing a combination of moves requires speed, timing and good memory. The player has to remember the button sequence and produce it perfectly at the right time. Games player revel in this type of game play and the controller offers another dimension to this. The controller could be deployed in console games and would be ideal for mobile games applications.

Thus, in some embodiments of the invention a control panel as described above may be connected to a physical interface unit with separate keys corresponding to each of the plurality of individual controls, user activation of the key for a control determining the extent of the indicator for that control.

Viewed from another aspect of the invention, there is provided apparatus for playing a video game, comprising a display which displays scenes from the game and which also displays at least one controller adapted to select a plurality of actions, wherein the controller comprises a visible marker, and means for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent; wherein the apparatus includes a keypad and operation of a key is used to vary the extent of the indicator.

In one preferred embodiment for each controller there is a plurality of circumferentially spaced markers corresponding to the plurality of actions for the control, and to select a particular action corresponding to a particular marker, that marker must be aligned with the target sector. In a preferred embodiment, there are three or four or more possible actions, i.e. with three or four or more equally spaced circumferentially arranged markers. Preferably the background is a circle around which the markers rotate continuously. A minor segment of the circle, such as a third or a quarter, is marked to identify it as the target sector.

In an alternative embodiment, the controller has a single marker, and there is a plurality of visible sectors of the background which are allocated to respective ones of the plurality of actions for the control, and to select a particular action corresponding to a particular sector, the marker must be aligned with that particular sector. Preferably, the marker further serves as the visible indicator whose extent can be varied by a user. Preferably, the marker is in the form of a bar of variable extent which sweeps around the background. The background is preferably in the form of a circle, which may be divided into segments, such as three or four or more equally sized segments.

Preferably, there is a plurality of controllers, such as four, and there is a separate key for each controller, to vary the extent of the indicator.

The controller may have any features of the controls described in connection with other aspects of the invention.

The invention also extends to computer software product containing instructions which when run in data processing apparatus will cause the apparatus to display the control panel or the controller or controls on a screen. This may be provided in a non-transient physical form such as on a DVD or other data storage device, or in signals supplied for a remote location, such as over a network such as the Internet. The software may also include BCI functionality.

It will be appreciated that whilst in the preferred embodiments there is an indicator which must reach a predetermined extent, that is a system particularly suited to use with BCI. However, in general the various aspects of the invention can use an alternative method of selecting a desired marker when in the target sector. Thus in general the control used in various aspects of the invention for selecting one of a plurality of actions, may comprise a visible marker, and a system for effecting continuous relative rotation of the marker with respect to a background, the background including a visible target sector; the control further comprising an indicator which can be varied by a user using a brain-computer interface without physical manipulation whilst there is relative rotation between the marker and the background, so as to cause a selection action when a chosen marker is aligned with the target sector. Furthermore, when the control is operated by manual implementation without using a brain-computer interface, the control used in various aspects of the invention for selecting one of a plurality of actions, may comprise a visible marker, and a system for effecting continuous relative rotation of the marker with respect to a background, the background including a visible target sector; the control further comprising a selection controller, such as a key or the like, which a user can manipulate whilst there is relative rotation between the marker and the background, so as to cause a selection action when a chosen marker is aligned with the target sector.

Thus, viewed form another aspect, the invention provides a control for selecting one of a plurality of actions, wherein the control comprises a plurality of spaced visible markers each associated with a respective action, and a system for effecting continuous relative rotation of the markers with respect to a background, the background including a visible target sector; the control further comprising a control element which can be used by an operator whilst there is relative rotation between the markers and the background so as to cause a selection operation when there is alignment of a chosen marker and the target sector so as to select the action associated with that chosen marker; and wherein the control is adaptive so that the number of possible actions is varied and the number of visible markers is varied accordingly.

All of the features of other aspects of the invention which include a plurality of rotatable markers are also applicable to this aspect of the invention.

In embodiments of the various aspects of the invention there is continuous relative rotation of the marker and the background. However there may be temporary interruption of rotation when the indicator reaches the predetermined extent, so that it is apparent that an action has been selected.

Some embodiments of the invention will now be described with reference to the accompanying drawings, in which:

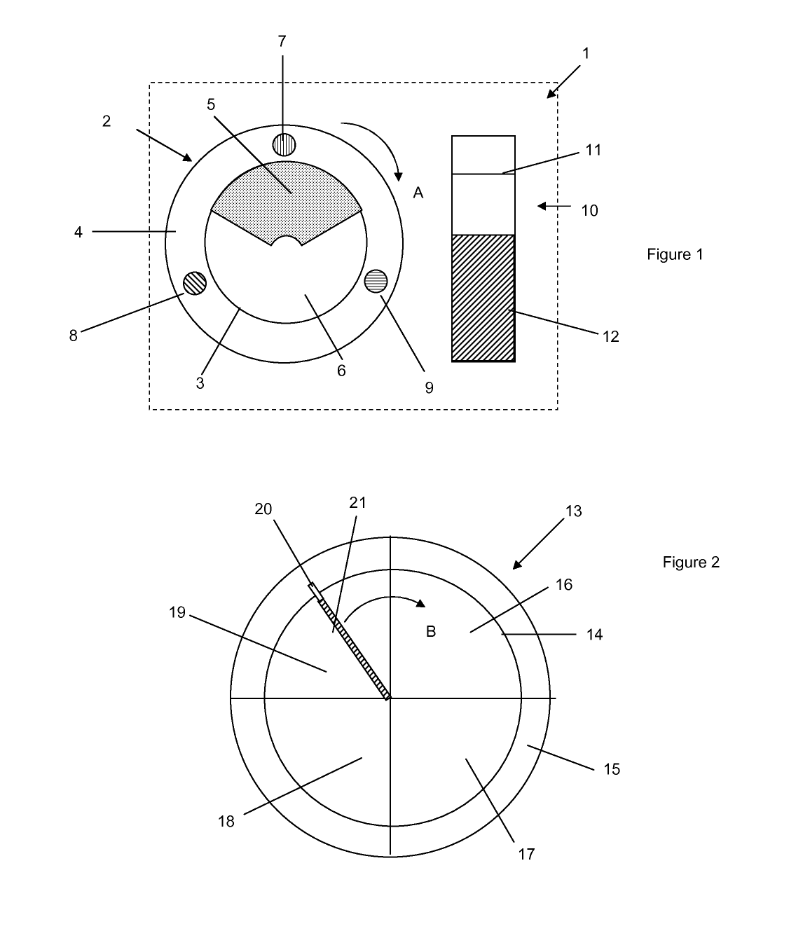

FIG. 1 is a view of an individual control;

FIG. 2 is a view of an alternative individual control;

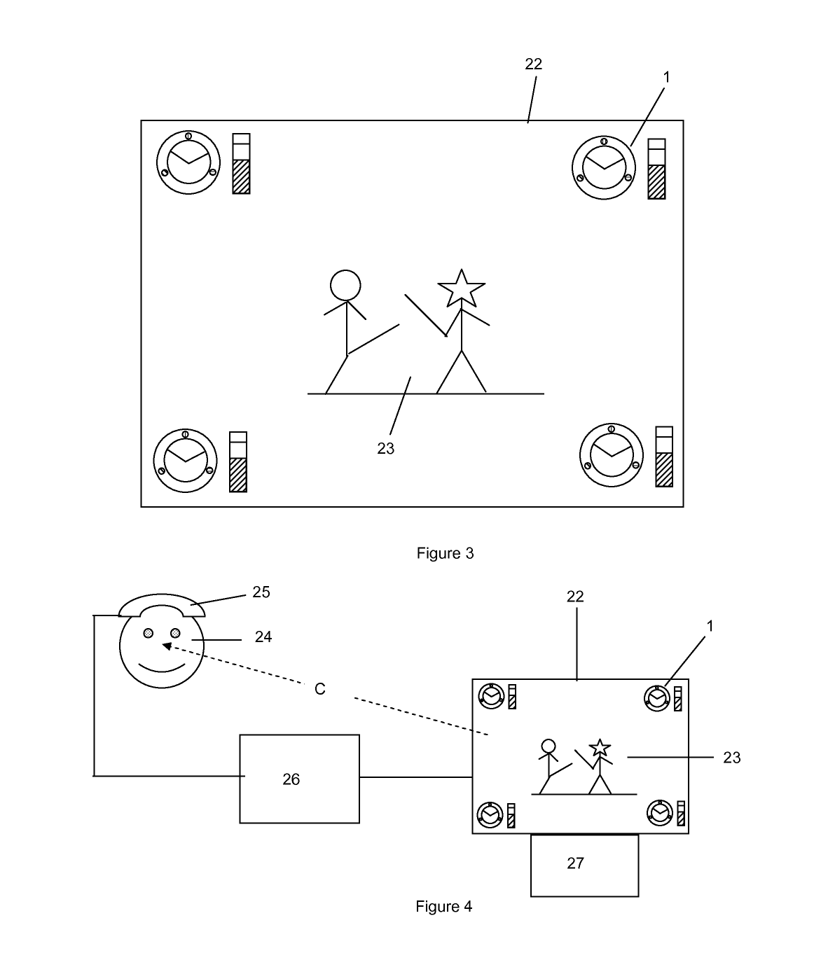

FIG. 3 is a view of a screen displaying four individual controls and some action in a game;

FIG. 4 shows an overall system with a BCI; and

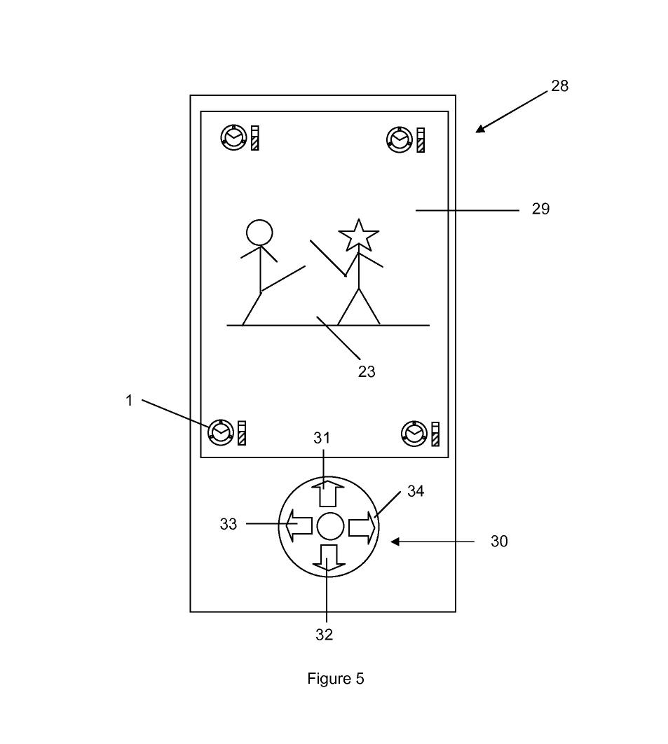

FIG. 5 is a view of a smartphone incorporating the invention;

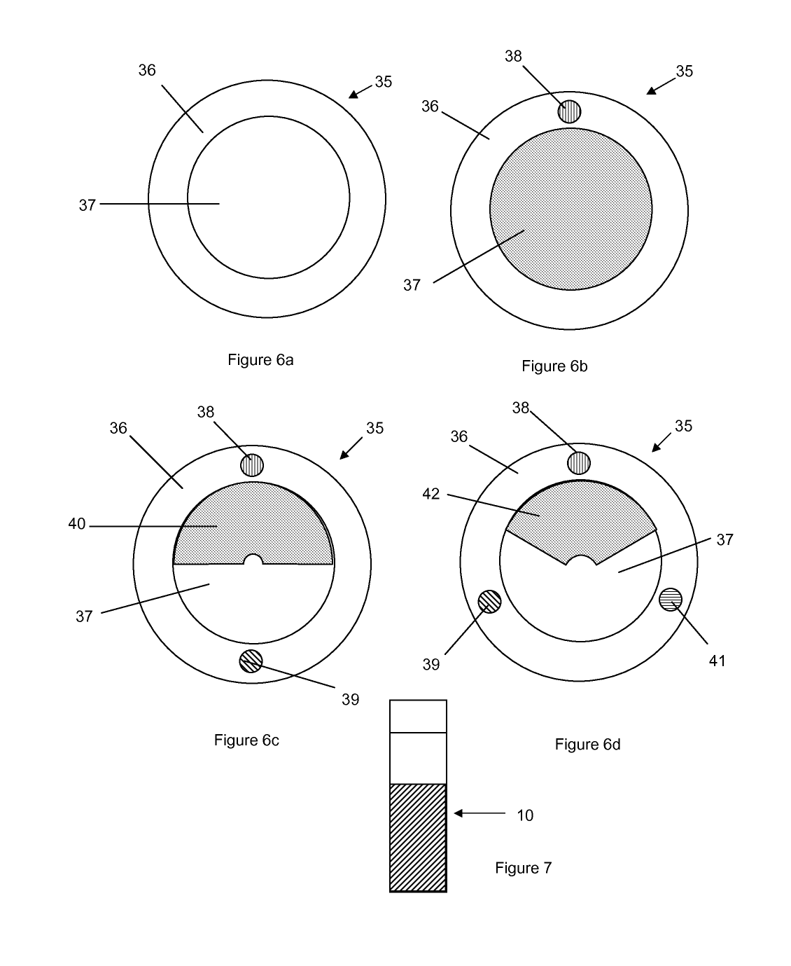

FIGS. 6a to 6d show possible states of an adaptive control;

FIG. 7 shows the bar indicator used with the adaptive control of FIGS. 6a to 6d; and

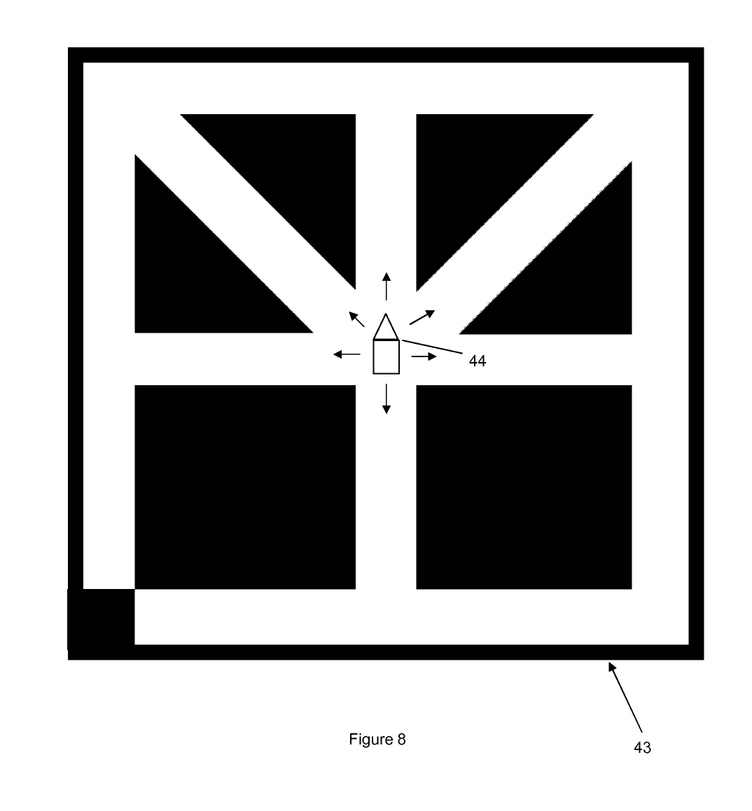

FIG. 8 shows a robot vehicle in a maze which is controlled using the adaptive control of FIGS. 6a to 6d.

Referring now to FIG. 1, the control 1 includes a circle arrangement 2 comprising an inner circle 3, surrounded by a ring 4. The inner circle is marked into a minor, target segment and a major segment. The outer ring carries three markers 7, 8 and 9 spaced equally around its circumference, corresponding to different functions to be performed. The outer ring rotates continuously in the direction of arrow A so that the markers are continually passing into and out of alignment with the target segment 5. The control also includes a bar indicator 10. This includes a target line 11 and an extendible bar portion 12, The bar 12 is extended to the line 11 under the control of a user, in this embodiment using the Brain Computer Interface described with reference to FIG. 4. When the bar has reached the target line 11 and a marker is in the target segment 5, the outer ring 4 stops rotating and the function corresponding to that marker will be carried out.

FIG. 2 shows a different embodiment of a control 13 for use with a Brain Computer Interface. The comprises an inner circle 14 and an outer ring 15. The circle and ring are divided into four equal sectors 16, 17, 18 and 19, A hand 20 rotates continuously in the direction of arrow B. This carries an extendible bar 21 whose extent is controlled by a user. When the bar extends into the ring 15 in a sector, the function associated with that sector is carried out.

FIG. 3 shows a screen 22 with a control 1 in each of its four corners. Also on the screen are presented images 23 for a game, in this case representing two figures fighting. The actions of the figures are controlled by the controls 1.

FIG. 4 shows the screen of FIG. 3 incorporated in a Brain Computer Interface System. A user 24 wears apparatus 25 for detecting the electrical activity of the brain, i.e. brainwaves. These signals are fed to a brainwave analyser 26 which feeds four channels of UDP data to data processing apparatus 27 connected to the screen 21. The controls 1 interact with software for the game to alter the movements of the FIG. 23. Arrow C indicates visual feedback to the user 24.

FIG. 5 shows a smart phone 28 with a screen 29 and an arrow control pad 30. This has up, down, left and right arrow keys 31, 32, 33 and 34. The smart phone is running software for the game, and the screen displays the four controls 1 in its corners, and action 23 from the game. In this embodiment brain activity is not used to operate the bar indicator 10. Instead a key 31, 32, 33, 34 operates the respective bar indicator so that its length increases to reach the target line 11 when the appropriate target 7, 8, or 9 is in the target segment 5.

In one embodiment the circle is associated with foot motor imagery and rotates continuously so that each cursor or marker does one full rotation every 2.4 seconds. If the users want to select a particular cursor and thus the function associated with that cursor they must stop the circle rotating when that cursor is on the circumference of the target segment in the inner circle. To achieve this the user must perform left motor imagery and increase the indicator, or feedback bar above a pre-set threshold, namely the target line. If the feedback bar exceeds the threshold the circle is stopped. If a particular marker is located on the circumference of the target segment in the inner circle the function associated with that command is chosen.

In some embodiments the controller is used for a Battle Mode Fighter Game and an Adventure Mode Fighter Game that can be controlled using a BCI. The idea of having two game characters fighting is not novel but to suit BCI limitations (accuracy and speed of control) the games have been designed with novel concepts to ensure that it suits the BCI.

Combat Mode involves fighting another character; the character can only be attacked using the correct command (i.e., one of the 12 commands which activate a punch, kick etc). The required action command is displayed above the character and the player must perform the correct command before a timer counts down. This may seem trivial but this game offers great potential for BCI based games play. It is slow enough to be operated by a BCI and test the user's ability to perform the correct motor imagery. The novelties of the timing and predicting when the circle cursor will be in the correct location, provision of specific commands in conjunction with the controller render the complete package particularly advantageous.

In the Adventure Mode, the player is allowed to choose a warrior to pass through several levels by moving forward and killing enemy players. The particular monsters will appear on the way to the end of each level with corresponding texts over their heads to indicate to the user which command is required to attack the enemy. The player is free to move and attack on the platform but only by performing the desired move(s) to pass the enemy. The monsters will also move and attack following a constant frequency depending on the difficulty of the level. And the character will be hurt if it is attacked by the monsters. Once all monsters on this level are killed and the character has moved to the end of the level, it will go to another level automatically. The difficulty will increase level by level by adding the number of moves desired to kill a monster and enhancing the move frequency of the monsters. After passing several levels, there is a boss that the character has to face. At that time, the game will be switched to Combat Model where the character will have combat with the boss. Again this may appear trivial but offers a clear framework that the games can be controlled using a motor imagery BCI and offers a range of challenges for the gamer including timing and accuracy of commands.

The essential element of a good game are play, a goal, rules and pretending and these game designs offer that and thus are expected to be intriguing to game players (be they able bodied or disabled). BCI controlled games are the only option for some disabled users (e.g., spinal cord injury victims) who may at one time been avid video players but may no longer be able to use a games controller but still have the intellectually capacity to understand game play and are eager to play. This fighting game for the first time offers this potential. Non-trivial game play require a challenge and this game (controlled via BCI and brainwaves) will be challenging for able bodied and disabled users alike. The controller can be integrated with other games also.

The above games can also be controlled using the four arrow keys on key board or four buttons on the display screen of a smart phone or other hand held device. Each arrow key activates the feedback bar and the users must time the arrow key press to perform the correct action. This offers a challenge to able-bodied games players. Arrow key press reaction time sensitivity can be altered along with circle rotation speed to increase the challenge. More circles and rotation can be incorporated to create a gaming interface which is increasingly complex for able bodied users but increasingly challenging and exciting to play. Such an interface involving timing and rhythmic control of feedback bars and rotating circles is not yet available.

Timing and rhythm form key elements of many games. Rhythm challenges, tests of the player's ability to press the right button at the right time, feature in dance games and many others. The popularity of rhythm-based games has resulted in a significant aftermarket in speciality input devices including dance mats, electronic drums and guitars (e.g., Guitar Hero™)

In addition, many fighting games require complex sequences of joystick moves and controller button presses that, once mastered, allow the players avatar to perform powerful features. Executing a combination of moves requires speed, timing and good memory. The player has to remember the button sequence and produce it perfectly at the right time. Games player revel in this type of game play and the controller of the invention offers another dimension to this. The controller could be deployed in console games and would be ideal for mobile games applications. There is thus provided a new games controller interface which enhances the timing and rhythm challenges in game play. The games controller can interfaced with a range of game genres.

The information transfer (IT) rate of brain-computer interface devices using motor imagery is low, much lower than other interface devices. The arrangements of the invention offer a method of increasing the IT rate without increasing the number of motor imageries (classes) necessary to be performed by the user and without increasing the time required when choosing from 12 options as opposed to 2-3. A new game offers new gaming scenarios which are suitable for BCI in conjunction with the new control system.

FIGS. 6a to 6d show an adaptive control 35 with an adaptive appearance, shown in four possible states which are respectively no functions controlled; one function controlled; two functions controlled; and three functions controlled. The adaptive control 35 is used in conjunction with a bar indicator 10, shown in FIG. 7, which is identical to that of the embodiment of FIG. 1 and is used in the same way. The adaptive control 35 has an outer ring 36 which is movable around an inner circle 37. In FIG. 6a the control 35 is blank and is thus disabled with no functions to control. In FIG. 6b the adaptive control has one marker 38 on the outer ring and the entire inner circle 37 is shaded grey, as being the target sector, meaning that stopping the marker 38 at any point will select the function ascribed to that marker. In FIG. 6c, there is a second marker 39 diametrically opposite the first marker 38, and only the upper semicircle 40 of the circle 37 is shaded grey as the target area. Stopping a marker in that target area will select the function ascribed to that marker. Finally, FIG. 6d shows a third marker 41 and only an upper third segment 42 of the inner circle shaded grey as the target sector. In this form the control is used in the same way as that of the embodiment of FIG. 1. This adaptive control can be used in many arrangements but will be described with reference to controlling a robot 44 in a maze 43 as shown in FIG. 8. The robot can be a physical robot in a physical maze or a virtual robot in a virtual maze. For example, the robot could be a physical robot controlled by a person of restricted mobility to perform tasks around a home. In this embodiment, the maze is in the context of a testing environment.

In embodiments of the invention in which the control is adaptive, there may be provided a configuration module operated by software using a microprocessor to configure the appearance of the control, e.g. the number of markers and optionally the size of the target sector, before using the control. In the preferred embodiments of using an adaptive control, however, the control is adaptive during use and the adaptations are controlled by for example the software operating a video game or software operating a robot, so as to adapt the control during use to different circumstances as the game progresses or as the surroundings of the robot change, for example.

In this embodiment, there will be a control panel with two adaptive controls, one on the left and one on the right, each with its associated bar indicator.

In this embodiment, at any point in the maze 43 the robot can move in six directions as shown by the arrows on FIG. 8, namely forwards, backwards (which means that the robot spins round by 180°), left at 90°, left at 45°. right at 45° and right at 90°. The robot has a sonar or other obstacle sensing arrangement that identifies obstacles in the directions of the arrows shown on FIG. 8, although for the reasons explained below, it is not necessary to detect obstacles to the rear.

In order to provide sufficient user options, the maze contains 90° degree junctions both left and right, T-junctions, crossroad type junctions and dead ends. This type of environment has been chosen because adjoining paths in indoor environments are most commonly perpendicular. There are also paths that fork off from other paths at 45 degree angles, both to the left and right. This will add another level of complexity to the environment and will offer more possible routes for the robot to navigate.

The user must be able to easily identify walls and obstacles as well as areas in which the robot can manoeuvre. Therefore the walls and obstacles appear black in the simulated environment and areas in which the robot can move will be white. This design is minimalist enough to ensure that user focus will be on the robot.

The width of each path in the maze that the robot can take will be roughly the same to allow for consistency in the robot control paradigm. This will allow the robot to recognize when it is at a junction so that it can then gather accurate sensor information to be returned to the user.

The first thing that the robot does as soon as its control program is executed, is to sense its surroundings. The robot will do this by returning values from its sonar sensors interface to the control program. These values will then be used to construct an abstract map of the robot's surroundings so that the user knows what robot commands are available for selection.

The six directions in which the robot can sense will give the user adequate control of the robot in the testing environment of this embodiment. It is worth noting that the robot will not need to sense obstacles directly behind. The reason for this is because it is assumed that once the robot executes its first command, it will begin moving from its start point in a linear direction. From that point on, the robot will be able to turn 180 degrees and return in the direction from where it came as an assumption has been made that the structure and design of the environment remains static, i.e. obstacles or walls will not be constructed during the simulation. If more than 6 options are available an environment a third circle with options can be introduced and accessible using a third BCI motor imagery command enabling selecting of up to 9 different options.

The robot must be able to detect when it is at a junction and the following pseudo code shows how this will be achieved in the implementation stage:
Robot is moving straight ahead
If sensor value returned in given direction is less than threshold
   Stop robot
   Sense directions in which robot can move
   Send options to Controller
End if

At this point the robot waits for the user to select a robot command and the process begins again. This pseudo code will be performed for each of the directions shown in FIG. 8. This makes up a unique combination of junctions through which the robot can navigate.

One aspect of the surroundings sensing strategy for the robot that must be considered is the fact that the robot must be able to sense more than one junction at a time. It will not be sufficient if the robot simply stops at the first junction it finds and relays that information back to the user. This design could lead to instances where misrepresentation of available robot actions occurs. For example the robot may actually be able to turn left 45 degrees and left 90 degrees but only the 45 degrees left option is relayed to the user as this was the junction, which was first detected by the robot. To eradicate this problem the robot will continue into the junction by a set distance so a more accurate scan of its surroundings including possible routes to take can be performed.

Another important design feature that will be incorporated into the robot's control strategy is the detection of a dead end. No matter what command is being executed by the robot, it must stop a safe distance away from a dead end or object blocking route as soon as one is detected. This feature will also be active when the robot is moving further into a junction to obtain more accurate sonar values, to ensure that any collisions are avoided. The detailed pseudo code that includes dead end detection is shown below:

```
Robot is moving straight ahead
If sensor value returned in given direction is less than threshold
      If robot can continue forward
            Continue into junction by set distance
            Stop robot
      End if
      Stop robot
      Sense directions in which robot can move
      Send options to Unity GUI
End if
```

In order to deal with any scenarios in which the robot is moving straight ahead but is not quite travelling perpendicular to the wall, another strategy will be implemented. Sonar sensors will be used to correct the robot's direction while it continues moving. This will eliminate unnecessary stoppages that would add to user control times and overall mission times. Threshold levels similar to those used to detect dead ends will be used and when the sonar sensors on either side of the robot return values that cross these threshold levels, the command will be sent to align the robot so that it doesn't collide with the wall. The following piece of pseudo code shows how the alignment strategy will be implemented:

Robot is moving straight ahead
While side sensor values are above detection threshold
Turn robot away from wall
End while

Note that the alignment control strategy will only be invoked to correct slight discrepancies between the robot's trajectory and the adjacent wall. E.g. if the robot is travelling and detects a wall at 45 degrees, it will stop as this will be identified as a junction.

The robot will be able to execute the following commands when chosen by the user:
Straight Ahead
Turn left 45°
Turn left 90°
Turn right 45°
Turn right 90°
Turn 180°
Stop
Wander

The straight ahead command will send the robot straight ahead until it reaches a junction but it must also contain logic to ensure that the robot successfully leaves the current junction. Each of the turning commands will initially cause the robot to turn on the spot by the specified amount and then the robot will continue straight ahead until the next junction is reached. This will halve the user's control time by completing both actions consecutively without requiring two commands and this will decrease the overall mission times significantly.

When the robot executes the turn 180 degrees option, the robot will first turn 180 degrees and then check for an obstacle in front before moving straight ahead. The stop command will only be available to the user once the robot is in motion as there is no need to present this option to the user once the robot is already stationary. The aim of this embodiment is to display the minimum amount of options available to the user at a given time so that user error is minimized.

The Wander command is only available to the user when the robot is moving. Once this command is selected by the user the robot will continue in a straight line until it reaches a dead end or an obstacle. The robot then uses its sonar sensors to detect the clearest path: left or right, and based on this information the robot will continue to move in this direction.

The total number of different combinations of robot commands that can be possibly displayed by the control panel, once the robot has scanned its surroundings, is 2⁵, i.e. 32. This is because each option has only two possible states—available or not available and there are 5 options whose availability can change. The left circle will have 8 different combinations (2³) and the right circle will have 4 different combinations (2²). The combination of commands that the robot can execute is dependent on the data returned from the sonar sensors.

The goal of the control panel with adaptive controls is to present the information as clearly as possible to the user without distracting the user from their objective: namely to control the robot with their brainwaves. This activity in itself requires a lot of concentration from the user so the design of the interface must be as minimalist as possible. Therefore only the information that is critical to the user will be displayed on the control panel. The fact that the user will not have the traditional means for inputting information, such as a keyboard and mouse, is also another issue that has impacted on the design choices for the control panel. The user must be made aware of the following:
What robot commands are available to them at any given time
How accurate their timing has to be to select the desired command
The command they have just selected

Text will be used to display the options available for each control. The text will be displayed in the same position throughout the execution of the simulation so that the user can quickly learn where to look to acquire information regarding the status of the robot. The two most important parts of the control panel will be the areas that contain the rotating circles and threshold meters (bar indicator 10). The rotating control circle and threshold meter that relate to left arm motor imagery will be located at the bottom left of the display. Conversely the rotating circle and threshold meter that relate to right arm motor imagery will be located at the bottom right of the user interface, to keep the design consistent with previous versions.

The most important part of the whole user interface is the adaptive rotating circles. Without these, the control panel would always display a set number of possible robot commands for the user to choose from, and this would only distract the user from correctly selecting their desired option. There will be labels that correspond to each of the available options on the rotating circles and these labels will also have to be updated accordingly in order to give clear feedback to the user. When the robot has stopped and assuming that all possible options are available to the user, in this embodiment the text labels for the left circle will be:
Turn left 45°
Turn left 90°
Straight ahead

For the right circle, again assuming that the robot has all available options, the labels will be:
Turn right 45°
Turn right 90°
Turn 180°

The labels described above will each have coloured markers that correspond to coloured markers on each of the circles, so that the labels act as a key. They will also be visible or not depending on whether or not the option is available to the user, determined based on the sonar feedback from the robot and will always be consistent with the information being expressed on the rotating circles.

The adaptive rotating circle relating to the left hand BCI command will, at any given time, display a total of 0-3 options to the user. The adaptive rotating circle that relates to right hand BCI control command BCI will however display 1-3 different options at any given time as turn 180 degrees will always be available to the user. The background of the rotating circle will also play a key part in relaying information back to the user as it must be changed depending on the number of options being displayed on the circle at a given time.

If there are no options available on the given BCI circle, the background of the circle will be plain and there will be no option markers that rotate around the circle.

If there is only one option available to the user then the background should be completely shaded to indicate that the one option will be chosen regardless of where its corresponding marker on the circle is stopped.

If there are two options available to the user the circular background will be split equally into two 180° sectors, with the top sector indicating the “selection sector” in which to stop the desired marker. This means the two individual option markers will spend half the time in the “selection sector” for one complete rotation around the circle.

If there are three options available to the user the circular background will be split equally into three 120° sectors, with the top sector indicating the “selection sector” in which to stop the desired marker. This means the three individual option markers will spend a third of the time in the “selection sector” for one complete rotation around the circle.

As explained above, the difficulty in selecting an option increases for the user when more options are added to the circle, so it is important to display only the options available to the user at any given time.

In order to keep the design consistent, the label positions will not change on the user interface. The first label that is available for a particular control will have its corresponding marker positioned at the very top of the rotating circle at the start of the rotation.

As discussed earlier the option to turn the robot 180° on the right circle will always be available for selection by the user. However, in a modification if there is another option available on the right circle and there are no options available on the left circle, the Turn 180° option will be transferred to the left circle so that the difficulty for the user is lowered. This is preferably the only time that a label will change so that the user can quickly become familiar with the location of each option label on the control panel.

When the robot is in the process of moving, the only two options that will be available to the user will be “Stop” and “Wander”. If the user however selects Stop, then the robot will stop and scan its surroundings and the whole robot control process will continue as if the robot had stopped at a junction or dead end.

Once movement of the left or right arm is imaged, the corresponding threshold bar will rise toward the threshold level. Only when the bar rises above the level is it accepted that the user is making a robot command choice. However the user will have to keep the MI bar above the threshold level for a pre-specifed duration, depending on the users BCI control proficiency, so to lower the rate at which wrong commands are chosen. Once this has been done, the command will be sent to the robot.

The communication between the robot and the control panel must be adequate to allow data to be continuously exchanged between the control panel and the robot. The sending of data using the User Datagram Protocol (UDP) is relatively straightforward as UDP is connectionless and will be sent to a destination port regardless of whether or not that port is listening for UDP. The process of sending UDP will be represented as a function that is called iteratively. The strings that are sent from the robot to the control panel will range from “aa” to “bg”, depending on what junctions the robot has detected. The strings that are sent from the control panel to the robot will range from “1” to “8” as there are eight commands which the robot can execute.

The receiving of data via UDP is not as straightforward as the process of sending data via UDP as both the robot and the control panel have to be continuously listening for any incoming packets. To make this possible, a listening thread must be made so that both the robot and the control panel can listen for incoming packets in the background while concurrently executing other code. Once the listener thread has started, UDP can then be received continuously without disrupting the flow of execution of the main code.

BCI games and robot/vehicle controls can be used by able bodied and disabled users. The controller can be used from anything to robot/wheelchair control to environmental control (smart home) or virtual spelling devices.

BCIs have been used to operate assistive technologies for alternative communication and control for the disabled, rehabilitation (post stroke using neuro-feedback) and games, among others. The new interface will improve the information transfer rate and therefore make BCIs more viable in a range of different applications.

In the preferred embodiments of the invention there is provided a control panel for controlling the actions of an object using Brain Computer Interface technology. The panel includes a control adapted to select a plurality of actions. The control comprises a visible marker and means for effecting continuous relative rotation of the marker with respect to a background. The background includes at least one visible target sector. The control further comprises a visible indicator whose extent can be varied by a user whilst there is relative rotation between the marker and the background. For an action to be selected, alignment of the marker and the target sector must coincide with the indicator having reached a predetermined extent. The control may be adaptive to display differing numbers of markers and different target sectors, depending on the actions permissible at any given time.

1. A control panel comprising a plurality of individual controls, each of which is adapted to select a plurality of actions, wherein each control comprises a visible marker, and means for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent.

2. A control panel as claimed in claim 1, wherein the panel is connected to a brain-computer interface for a user to select actions without physical manipulation by altering the extent of the indicator.

3. A control panel as claimed in claim 2, wherein the brain-computer interface permits a user to select actions by movement imagination.

4. A control panel as claimed in claim 1, wherein for each individual control there is a plurality of circumferentially spaced markers corresponding to the plurality of actions for the control, and to select a particular action corresponding to a particular marker, that marker must be aligned with the target sector.

5. A control panel as claimed in claim 4, wherein each individual control is adaptive to display a different number of markers in dependence on the number of actions available for that control.

6. A control panel as claimed in claim 5, wherein an individual control is adaptive to display no markers when there are no actions available for that control.

7. A control panel as claimed in claim 5, wherein an individual control is adaptive to display a single marker when there is a single action available for that control.

8. A control panel as claimed in claim 5, wherein an individual control is adaptive to display a number different backgrounds with different target sectors, in dependence on the number of actions available for that control.

9. A control panel as claimed in claim 8, wherein an individual control is adaptive to display two diametrically opposed markers when there are two actions available for that control, with a circular background in which the target sector is a semicircular portion of the background.

10. A control panel as claimed in claim 8, wherein an individual control is adaptive to display three or more equally spaced markers when there are three or more actions available for that control, with a circular background in which the target sector is a minor sector of the background.

11. A control panel as claimed in claim 1, wherein for each individual control there is single marker, and there is a plurality of visible sectors of the background which are allocated to respective ones of the plurality of actions for the control, and to select a particular action corresponding to a particular sector, the marker must be aligned with that particular sector.

12. A control panel as claimed in claim 11, wherein the marker further serves as the visible indicator whose extent can be varied by a user.

13. A control panel as claimed in claim 12, wherein the marker is in the form of a bar of variable extent which sweeps around the background.

14. A control panel as claimed in claim 1, wherein the visible indicator whose extent can be varied by a user is separate from the or each visible marker.

15. A control panel as claimed in claim 14, wherein the indicator is linear.

16. A control panel as claimed in claim 11, wherein each individual control is adaptive to display a different number of visible sectors in accordance with the number of actions available for that control.

17. A control panel as claimed in claim 16, wherein an individual control is adaptive to display no sectors when there are no actions available for that control.

18. A control panel as claimed in claim 16, wherein an individual control is adaptive to display a single sector when there is a single action available for that control.

19-26. (canceled)

27. A control for selecting one of a plurality of actions, wherein the control comprises a visible marker, and a system for effecting continuous relative rotation of the marker with respect to a background, the background including at least one visible target sector; the control further comprising a visible indicator whose extent can be varied by a user whilst there is relative rotation between the marker and the background; and wherein for an action to be selected, alignment of the marker and the target sector must coincide with the indicator having reached a predetermined extent; and wherein the control is adaptive so that the number of possible actions is varied and the marker and/or background is varied accordingly.

28. A control as claimed in claim 27, wherein the control has a plurality of circumferentially spaced markers corresponding to the plurality of actions for the control, and to select a particular action corresponding to a particular marker, that marker must be aligned with the target sector, and the control is adaptive to display differing numbers of markers.

29. A control as claimed in claim 28, wherein if the number of markers is reduced, the size of the target sector is increased at the same time.

30. A control as claimed in claim 27, wherein the control has a single marker, and there is a plurality of visible sectors of the background which are allocated to respective ones of the plurality of actions for the control, and to select a particular action corresponding to a particular sector, the marker must be aligned with that particular sector; and wherein the control is adaptive to display differing numbers of sectors of the background, in accordance with the number of options available.

31-41. (canceled)

42. A control panel as claimed in claim 1, incorporated in video game apparatus.

43. A control as claimed in claim 27, incorporated in video game apparatus.
